(19) United States
(12) Patent Application Publication
(10) Pub. No.: US 2018/0361374 A1
(43) Pub. Date: Dec. 20, 2018

(54) DEVICE SUITABLE FOR CENTRIFUGING AND METHOD USING SAME

(71) Applicant: Laboratoire Francais du Fractionnement et des Biotechnologies, Les Ulis (FR)

(72) Inventors: Alexandra ALARZA, La Plaine Saint Denis (FR); Julien BILLON, Le Plessis Robinson (FR)

(73) Assignee: Laboratoire Francais du Fractionnement et des Biotechnologies, Les Ulis (FR)

(21) Appl. No.: 16/061,166

(22) PCT Filed: Dec. 16, 2016
(86) PCT No.: PCT/FR2016/053509

§ 371 Date: Jun. 11, 2018

(30) Foreign Application Priority Data
Dec. 18, 2015 (FR) 15 62747

(51) Int. Cl. B01L 3/00; G01N 1/40

(52) U.S. Cl. CPC B01L 3/5021; G01N 1/4077; B01L 3/505; B01L 2200/0689; B01L 2300/0887; B01L 2300/123; B01L 2200/0647; B01L 2300/049

(57) ABSTRACT

The present invention relates to a device for processing a biological fluid comprising cells suspended in a liquid, the processing device being intended for use in a centrifugation step to separate the cells from the liquid, the processing device comprising:
a pouch suitable for receiving the biological fluid, the pouch having top and bottom edges that are distanced from one another along a longitudinal axis, the pouch being composed of two flexible layers that are placed one atop the other and integrally interconnected along an interconnection area, the interconnection area being provided so as to form, between the two layers, an inner space for receiving the biological fluid and at least one opening suitable for placing the inner space in communication with an outer environment,
at least one sealing member placed in the opening, for selectively opening and closing the opening,
the processing device being characterized in that the inner space has:
a top portion formed near the top edge and intended for receiving the supernatant liquid from the biological fluid after the centrifugation step, and
a neck formed near the bottom edge and intended for receiving a cell pellet from the biological fluid after the centrifugation step,
the top portion and the neck each having widths measured transversely to the longitudinal axis, the width of the neck being less than the width of the top portion.

The invention relates to a device able to receive a cell culture or a cell suspension, and suitable for centrifuging said cells.

In the field of biological assays and cell therapy, many methods exist for processing biological material (i.e. a patient sample), aiming to recover the elements required for the intended goal (i.e. analytical or therapeutic, respectively). Most often, these required elements consist of the patient's cells.

Among the various steps in existing methods, it is known to use centrifugation as a means of separating cells from a liquid, for later use. To this end, said cells are packaged in a particular device, and then centrifuged. Conventionally, after this step, two phases are obtained:
an upper solid phase, called the pellet, which contains the cells; and
a lower liquid phase, called the supernatant.
   Depending on the nature of the cells, the centrifugal force used, and the type of liquid in which the cells are suspended, the homogeneity of the cell pellet may vary.
   Indeed, it may be that after centrifugation, cell pellets are formed that are not firm. In such cases, the resulting pellets are not clearly separate from the supernatant. This is particularly the case for certain types of cells used in therapy. Resuspension of the cells in the supernatant or in the interface between the supernatant and pellet can then occur during subsequent handling of the device used for centrifugation, particularly the use of a plasma extractor, which can result in imperfect separation of the phases and therefore a loss in efficiency of the method.

There is therefore a need for a device capable of centrifuging and concentrating the maximum amount of cell pellet in a simple and easy manner, even in cases where the pellets formed are not firm.

The invention aims to overcome the problems mentioned above.

Indeed, the device according to the invention avoids these problems, due to its particular form. It enables easy collection, after centrifugation, of both the supernatant and the cell pellet formed. It also allows better cell concentration after centrifugation.

To this end, the invention proposes a device for processing a biological fluid containing cells suspended in a liquid, the processing device being intended for use in a centrifugation step to separate the cells from the liquid, the processing device comprising:
a pouch suitable for receiving the biological fluid, the pouch having top and bottom edges that are distanced from one another along a longitudinal axis, the pouch being composed of two flexible layers that are placed one atop the other and integrally interconnected along an interconnection area, the interconnection area being provided so as to form, between the two layers, an inner space for receiving the biological fluid and at least one opening suitable for placing the inner space in communication with an outer environment,
at least one sealing member placed in the opening, for selectively opening and closing the opening,
wherein the inner space has:
a top portion formed near the top edge and intended for receiving the supernatant liquid from the biological fluid after the centrifugation step, and
a neck formed near the bottom edge and intended for receiving a cell pellet from the biological fluid after the centrifugation step.
the top portion and the neck each having widths measured transversely to the longitudinal axis, the width of the neck being less than the width of the top portion.

The present invention also relates to a method for manufacturing a device as described above, providing the steps of:
forming a pouch suitable for receiving a biological fluid containing cells suspended in a liquid, and having top and bottom edges that are distanced from one another along a longitudinal axis, by placing two flexible layers one atop the other and integrally interconnecting them along an interconnection area, the interconnection area being provided to form, between the two layers, an inner space for receiving the biological fluid and at least one opening suitable for placing the inner space in communication with an outer environment, the inner space having a top portion formed near the top edge and intended for receiving the supernatant liquid from the biological fluid after the centrifugation step, and a neck formed near the bottom edge and intended for receiving a cell pellet from the biological fluid after the centrifugation step, the top portion and the neck each having widths measured transversely to the longitudinal axis, the width of the neck being less than the width of the top portion,
providing at least one sealing member placed in the opening, for selectively opening and closing the opening.

In some embodiments, the invention may comprise one or more of the following:

The biological fluid present in the device according to the invention may be a sample of blood, plasma, bone marrow, but also a cell culture sample or a cell suspension of any type. For example, the biological fluid may be a sample of stem cells or somatic cells which may or may not be genetically modified, a culture of immune cells, such as a culture of B cells and/or T cells, or samples of adipose tissue or stromal vascular fractions, as well as the cells derived therefrom. The usable stem or somatic cells and immune cells include myoblasts and/or their precursors, mesenchymal stem cells, hematopoietic stem cells and their derivatives, dendritic cells, and natural killer (NK) cells.

Preferably, the processing device according to the invention is such that the layers are composed of at least one film of heat-sealable material, the layers being heat-sealed along the interconnection area formed by a weld seam. The heat-sealable material may be selected from conventional materials known in the prior art, and in particular from polyvinyl chloride (PVC), polypropylene, ethylene-vinyl acetate (EVA), fluorinated ethylene propylene (FEP), and polyolefins.

Preferably, the interconnection area comprises a narrowing demarcating the top portion along the longitudinal axis at a distance from the top edge, the narrowing converging towards the neck. Preferably, the neck is formed in the longitudinal extension of the bottom edge.

The shape and size of the neck thus allow collecting the cell pellet. This is optimized by the narrowing converging towards the neck. This narrowing makes it possible to improve the concentration of cells during centrifugation.

Preferably, the top portion and the neck each have volumes, the volume of the neck being between 5% and 100% of the volume of the top portion, preferably from 5% to 50%, preferably from 15% to 30%.

Preferably, the width of the neck is between 5% and 80% of the width of the top portion, preferably from 10% to 40%. More preferably, the width of the neck is between 1 and 7 cm, preferably between 1 and 5 cm, preferably between 3 and 4 cm. More preferably, the width of the top portion is between 7 and 10 cm, preferably between 8 and 9 cm.

Preferably, the top portion and the neck each have lengths measured along the longitudinal axis, the length of the neck being between 5% and 100% of the length of the top portion, preferably between 10% and 50%. More preferably, the length of the neck is between 1 and 9 cm, preferably between 4 and 5 cm. More preferably, the length of the top portion is between 8 and 15 cm, preferably between 9 and 12 cm.

Preferably, the narrowing converging towards the neck is inclined at an angle α relative to an axis perpendicular to the longitudinal axis. This angle α is preferably between 10° and 80°, preferably between 200 and 40°. More preferably, this angle α is around 300.

The device of the invention comprises at least one opening. Preferably, said at least one opening comprises a bottom opening provided in the bottom edge in the neck.

Preferably, said at least one opening comprises a top opening provided in the top edge in the top portion.

Preferably, the device comprises at least one top opening provided in the top edge in the top portion, and at least one bottom opening provided in the bottom edge in the neck.

Finally, preferably the pouch comprises a fastening member, for securing to a centrifuge. This fastening member may be, for example, a perforated tab, a clip, or a device for clamping between two plates or two foams, to hold the pouch.

Preferably, the pouch comprises two side edges, said side edges extending parallel to one another between the top and bottom edges, and the neck is along one of the side edges.

More preferably, the fastening member is along the side edge located opposite the side edge comprising the neck. Preferably, according to this embodiment, the neck is located at the side edge end that is nearest the centrifugation axis of rotation. Thus, according to this embodiment, the neck is positioned inwardly, near the centrifuge rotor. The device of the invention is in fact intended to be placed in a centrifuge to be rotated about a centrifugation axis. The neck has a preferred position with respect to this axis. The neck is thus preferably located on the inner side edge, nearest the centrifugation axis of rotation.

The invention also relates to a method for manufacturing a device according to the invention, providing the steps of:
forming a pouch suitable for receiving a biological fluid containing cells suspended in a liquid, and having top and bottom edges that are distanced from one another along a longitudinal axis, by placing two flexible layers one atop the other and integrally interconnecting them along an interconnection area, the interconnection area being provided to form, between the two layers, an inner space for receiving the biological fluid and at least one opening suitable for placing the inner space in communication with an outer environment, the inner space having a top portion formed near the top edge and intended for receiving the supernatant liquid from the biological fluid after the centrifugation step, and a neck formed near the bottom edge and intended for receiving a cell pellet from the biological fluid after the centrifugation step, the top portion and the neck each having widths measured transversely to the longitudinal axis, the width of the neck being less than the width of the top portion.
providing at least one sealing member placed in the opening, for selectively opening and closing the opening.

This method is preferably such that the layers are composed of at least one film of heat-sealable material and allow, during the step of forming the pouch, heat-sealing the layers along the interconnection area in order to form a weld seam.

The invention also relates to a method for processing a biological fluid which makes use of a processing device according to the invention.

Preferably, the processing method providing the steps of:
placing, within the inner space of the pouch, a biological fluid comprising cells suspended in a liquid.
separating the cells from the liquid by subjecting the processing device to a centrifugation step,
collecting the supernatant liquid from the biological fluid in the top portion, and
collecting a cell pellet from the biological fluid in the neck.
   Preferably, in the first step, the biological fluid is placed within the inner space of the pouch. Then a centrifugation step takes place. This centrifugation can be carried out by any known and commercially available centrifuge. After centrifugation, a supernatant composed of the liquid from the biological fluid is thus obtained. The pellet is located in the bottom portion of the pouch, at the neck. It is then easy to collect either the pellet or supernatant as desired.

Other features and advantages of the invention will be apparent from the following description of specific embodiments of the invention given as non-limiting examples, the description being provided with reference to the accompanying drawings in which:

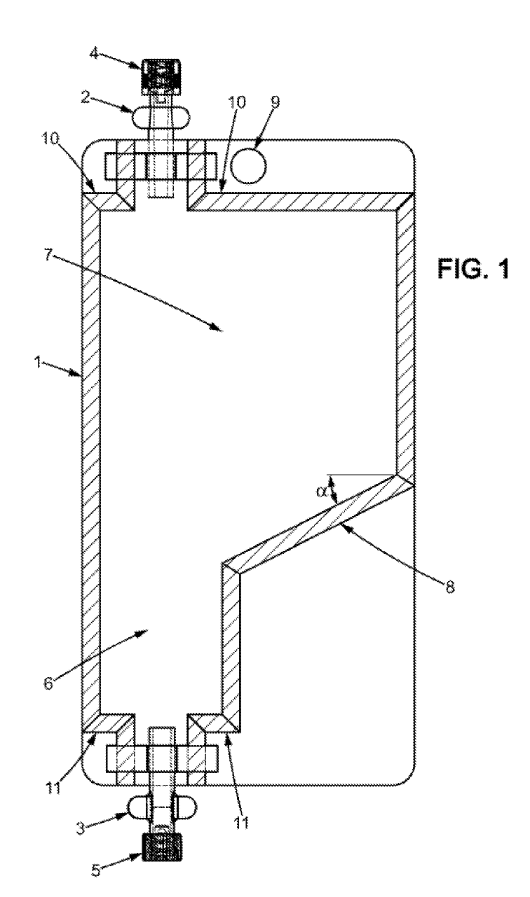

FIG. 1 is a representation of the device according to the invention.

In the FIGURE, the same references designate identical or similar elements.

The device of the invention comprises a pouch (1). This pouch comprises a top edge (10) and a bottom edge (11), said edges being at a distance from one another along a longitudinal axis.

In addition, the pouch is composed of two flexible layers that are placed one atop the other and integrally interconnected along an interconnection area, the interconnection area being provided to form, between the two layers, an inner space ((6) and (7)) for receiving the biological fluid.

The pouch comprises at least one opening suitable for placing the inner space in communication with an outer environment. Preferably, as mentioned above, said opening comprises a bottom opening (5) provided in the bottom edge in the neck. According to another embodiment, preferably said opening comprises a top opening (4) provided in the top edge in the top portion. Finally, according to another embodiment, preferably the pouch comprises at least one top opening (4) provided in the top edge in the top portion, and at least one bottom opening (5) provided in the bottom edge in the neck.

The opening may comprise at least one sealing member (2) or (3) for selectively opening and closing the opening.

Finally, the inner space has:
a top portion (7) formed near the top edge and intended for receiving the supernatant liquid from the biological fluid after the centrifugation step, and
a neck (6) formed near the bottom edge and intended for receiving a cell pellet from the biological fluid after the centrifugation step,

the top portion (7) and the neck (6) each having widths measured transversely to the longitudinal axis, the width of the neck being less than the width of the top portion.

With these dimensions, the neck is thus suitable for receiving the cell pellet during the centrifugation step. The top portion of the inner space will only contain supernatant.

Optimum recovery of the pellet is obtained due to the presence of a narrowing (8) which converges towards the neck. This narrowing reinforces the demarcation between the supernatant and pellet.

The narrowing (8) converging towards the neck is typically inclined at an angle α of between 10° and 80° relative to an axis perpendicular to the longitudinal axis.

The pouch (1) according to the invention may comprise a fastening member (9), particularly for securing to a centrifuge.

Preferably, the volume of biological fluid used, present within the inner space ((6) and (7)), is between 20 mL and 3 L.

### Example 1

The following protocol is provided to show that using the pouch according to the invention, for the centrifugation of cells, offers a better solution for collecting unstable cell pellets after centrifugation than using a conventional centrifugation pouch (for example a Macopharma pouch).

This study can be performed on multiple cell types: B cells and/or T cells, UCB (Unit Cord Blood) and adherent cells. The centrifugation parameters (speed, duration, acceleration, and braking) can be adapted to the cell type.

Comparison of the two pouches is performed based on the following criteria:
yield (number of cells after collection of the pellet after centrifugation/number of cells before centrifugation)
cell viability after using the pouch
phenotyping according to the cells used, and
volume remaining after collection of pellets

The results obtained show that the yield, phenotyping, or volume remaining after centrifugation, are better when using the pouch according to the invention. Cell viability remains substantially the same regardless of which pouch is used.

We can conclude that the asymmetrical pouch of the invention is a better solution for cell centrifugation than a conventional symmetrical pouch, and specifically for cells that yield unstable pellets.

1. Device for processing a biological fluid containing cells suspended in a liquid, the processing device being intended for use in a centrifugation step to separate the cells from the liquid, the processing device comprising:
a pouch suitable for receiving the biological fluid, the pouch having top and bottom edges that are distanced from one another along a longitudinal axis, the pouch being composed of two flexible layers that are placed one atop the other and integrally interconnected along an interconnection area, the interconnection area being provided to form, between the two layers, an inner space for receiving the biological fluid and at least one opening suitable for placing the inner space in communication with an outer environment,
at least one sealing member placed in the opening, for selectively opening and closing the opening,
the processing device being characterized in that the inner space has:
a top portion formed near the top edge and intended for receiving the supernatant liquid from the biological fluid after the centrifugation step, and
a neck formed near the bottom edge and intended for receiving a cell pellet from the biological fluid after the centrifugation step,
the top portion and the neck each having widths measured transversely to the longitudinal axis, the width of the neck being less than the width of the top portion.

2. Processing device according to claim 1, wherein the layers are composed of at least one film of heat-sealable material, the layers being heat-sealed along the interconnection area formed by a weld seam.

3. Processing device according to any one of claims 1 and 2, wherein the interconnection area comprises a narrowing demarcating the top portion along the longitudinal axis at a distance from the top edge, the narrowing converging towards the neck.

4. Processing device according to any one of claims 1 to 3, wherein the top portion and the neck each have volumes, the volume of the neck being between 5% and 100% of the volume of the top portion, preferably from 5% to 50%, preferably between 15% and 30% of the volume of the top portion.

5. Processing device according to any one of claims 1 to 4, wherein the width of the neck is between 5% and 80% of the width of the top portion, preferably from 10% to 40%.

6. Processing device according to any one of claims 1 to 5, wherein the top portion and the neck each have lengths measured along the longitudinal axis, the length of the neck being between 5% and 100% of the length of the top portion.

7. Processing device according to any one of claims 1 to 6, wherein said at least one opening comprises a bottom opening provided in the bottom edge in the neck.

8. Processing device according to any one of claims 1 to 7, wherein said at least one opening comprises a top opening provided in the top edge in the top portion.

9. Processing device according to any one of claims 1 to 7, wherein the pouch comprises a fastening member, for securing to a centrifuge.

10. Processing device according to any one of claims 1 to 9, wherein the pouch comprises two side edges, said side edges extending parallel to one another between the top and bottom edges, and wherein the neck is along one of the side edges.

11. Processing device according to claim 9 and 10, wherein the fastening member is along the side edge located opposite the side edge comprising the neck.

12. Processing device according to any one of claims 3 to 11, wherein the narrowing converging towards the neck is inclined at an angle c relative to an axis perpendicular to the longitudinal axis, of between 10° and 80°, preferably between 20° and 40°.

13. Method for manufacturing a processing device according to any one of claims 1 to 12, providing the steps of:
forming a pouch suitable for receiving a biological fluid containing cells suspended in a liquid, and having top and bottom edges that are distanced from one another along a longitudinal axis, by placing two flexible layers one atop the other and integrally interconnecting them along an interconnection area, the interconnection area being provided to form, between the two layers, an inner space for receiving the biological fluid and at least one opening suitable for placing the inner space in communication with an outer environment, the inner space having a top portion formed near the top edge and intended for receiving the supernatant liquid from the biological fluid after the centrifugation step, and a neck formed near the bottom edge and intended for receiving a cell pellet from the biological fluid after the centrifugation step, the top portion and the neck each having widths measured transversely to the longitudinal axis, the width of the neck being less than the width of the top portion,
providing at least one sealing member placed in the opening, for selectively opening and closing the opening.

14. Manufacturing method according to claim 13, wherein the layers are composed of at least one film of heat-sealable material and allow, during the step of forming the pouch, heat-sealing the layers along the interconnection area in order to form a weld seam.

15. Method for processing a biological fluid which makes use of a processing device according to any one of claims 1 to 12, the processing method providing the steps of:
placing, within the inner space of the pouch, a biological fluid comprising cells suspended in a liquid,
separating the cells from the liquid by subjecting the processing device to a centrifugation step,
collecting the supernatant liquid from the biological fluid in the top portion, and
collecting a cell pellet from the biological fluid in the neck.
